(19) United States
(12) Patent Application Publication
(10) Pub. No.: US 2013/0300841 A1
(43) Pub. Date: Nov. 14, 2013

(54) STEROSCOPIC IMAGE DISPLAY

(71) Applicant: Seijiro Tomita, Tokyo (JP)

(72) Inventor: Seijiro Tomita, Tokyo (JP)

(21) Appl. No.: 13/860,063

(22) Filed: Apr. 10, 2013

Related U.S. Application Data
(62) Division of application No. 13/272,167, filed on Oct. 12, 2011, now abandoned.
Application No. 13/272,167 is a continuation of application No. 11/511,522, filed on Aug. 29, 2006, now abandoned.

(51) Int. Cl. H04N 13/04

(52) U.S. Cl. CPC H04N 13/0454
USPC 348/51

(57) ABSTRACT

The present invention provides a stereoscopic image display which controls display mode of the stereoscopic image display according to the entered image signal and displays both 2D images and stereoscopic images at high resolution with better viewing. The stereoscopic image display is constituted of a device for comparing the image signal entered into the stereoscopic image to determine to either 2D image signal or stereoscopic image signal and a combined use type stereoscopic image display of 2D images and stereoscopic images which can display 2D images and stereoscopic images at high resolution by controlling illumination pattern of the light source device for the stereoscopic image display to provide better viewing.

### FIELD OF THE INVENTION

The present invention relates to a stereoscopic image display which controls the display mode of the stereoscopic image display according to the entered image signal in an environment where 2D image contents and stereoscopic image contents exist together, and can display the 2D images and stereoscopic images at high resolution for better view.

### BACKGROUND OF THE INVENTION

For conventional stereoscopic image display without glasses, many inventions have been made for technology of displaying stereoscopic image signals at high image quality. However, technologies have not been proposed yet for displaying 2D image signals at high quality by using a stereoscopic image display without glasses.

Without saying, it is possible to display 2D images in the stereoscopic image display mode using a conventional stereoscopic image display without glasses. However, since the display sorts the images to the left eye and the right eye, there have produced lots of problems including deterioration of resolution and constraint of observation position of the observer.

For example, as a stereoscopic image display without glasses displaying stereoscopic images shown in FIG. 11 is known a display (patent reference 1) in which image for the left eye and image for the right eye are alternately arranged on the screen per horizontal line in the lateral direction.

Patent reference 1 is unexamined patent publication No. H10-63199.

The stereoscopic image display described in the patent reference 1 sorts all horizontal scanning lines on the display screen to odd lines and even lines, displays image for the left eye and image for the right eye on the respective line and sorts them to the left and right eyes of the observer by optical means to display a stereoscopic image. This display method has solved a problem of reducing horizontal resolution of image to half that was a weak point of conventional lenticular system and parallax barrier system, but still has a problem that if the observer moves to the left or to the right from the central portion of the screen, the observer sees only the image for the left eye or the image for the right eye that were sorted to the left and the right. In this image, the horizontal lines are displayed every other line in the vertical direction, thus the resolution in the vertical direction is half and produced a problem. Especially, when 2D image signals are displayed, the observer can view 2D images in full resolution only at the observation position of the center as in the same way when stereoscopic images are displayed. It does not allow the observer to shift the observation position freely. If the position shifts to the left or the right even slightly from the central portion, it causes a problem of reducing the resolution in the vertical direction to half. Particularly, when character information most often used in 2D images are displayed, the vertical resolution is reduced to half to make character unreadable and to result in a big problem that information cannot be transmitted.

In the case where 2D image contents and stereoscopic image contents are displayed at high quality by using a stereoscopic image display, some methods can be viewed as a method for determining the entered image signal to a 2D image signal or a stereoscopic image signal and switching the display mode of the stereoscopic image display to display a best mode image. In conventional stereoscopic image displays, as a method for responding the entered 2D image signal and the stereoscopic image signal, it is considered that observers switch the display mode of the stereoscopic image display manually.

However, in the case where 2D images and stereoscopic images exist in a content together, e.g., in the case where a commercial image is first reproduced in three dimensional image at TV broadcast and the like, 2D image signals and stereoscopic image signals are so often switched to each other that it cannot be practical for the observer to handle manually. The observer gets messed up in the head due to the stereoscopical viewing, which is not good for eyes.

In order to treat such problems expected in the future, EIAJ has proposed in 1997 the 3D Information Standard according to the 3D signal type under “Transmission method of video signal by VBI” in CPR-1204 Report.

However, at that time, 525-line system as NTSC signal was prevailing, the above standard is that for the prevailing system. Identifying signal standard has not been taken into account for M-PEG signals which are recorded on DVD disk and the like generally in current use, 16:9 high vision signals, computer image signals and the like.

Furthermore, after 1997 when the standard was proposed, any identifying signal showing the 2D image has not been recorded in contents. Therefore, stereoscopic image displays to be put on the market have no method of automatically switching the display mode according to the entered image signal in the future.

Any unified identifying signal is not recorded in currently produced stereoscopic image contents yet. Accordingly, there is a problem that any identifying signal has not been recorded in a vast quantity of 2D image contents already created at all.

Furthermore, there are known a device for diffusing the light by spectroscopy means (patent references 2 and 3) as a 2D image-stereoscopic image compatible type of stereoscopic image display without glasses.

Patent reference 2 is publication after examination No. H8-105845.

Patent reference 3 is unexamined patent publication No. H10-260376.

The stereoscopic image displays without glasses described in the above patent references 2 and 3 are characterized in that display mode of the stereoscopic image displays is switched to the stereoscopic image display mode or the 2D image display mode by controlling dispersed liquid crystal phase.

The stereoscopic image displays without glasses described in the above patent references 2 and 3 are not structured in a manner that controls the light source to switch the display mode such as hereinafter described. Furthermore, there is no description of technology that the display mode of the stereoscopic image display is switched to the stereoscopic image mode according to the entered image signal, which is another feature of the present invention.

Moreover, as shown in FIG. 12, a stereoscopic image display without glasses is known that displays 2D images using the light source for stereoscopic images and the auxiliary light source placed backward (patent reference 4).

Patent reference 4 is WO2004/068213 A1.

The stereoscopic image display described in the patent reference 4 is a technology with a purpose of detecting the existence or non-existence of an observer by itself and switching the stereoscopic image display to the 2D display mode when no observer exists, but cannot switch the stereoscopic image display to the stereoscopic image display mode or the 2D image display mode according to the entered image signal such as the present invention.

Moreover, the stereoscopic image display described in the above patent reference 4 employs a method that switching to the 2D image display mode is performed by the stereoscopic image display using another light source (auxiliary light source) different from the light source for stereoscopic images, but since the auxiliary light source for displaying 2D images is a surface light source that is placed backward of the light source for stereoscopic images, the light source for stereoscopic images placed on the front takes a role of interruption. In the 2D image display mode, shadow and/or luminance irregularity is produced on the display screen, which is a big problem.

### SUMMARY OF THE INVENTION

According to the first object of the present invention, since display mode of the stereoscopic image display can be switched to the 2D image display mode or the stereoscopic image display according to the entered image signal, the observer does not require to switch the display mode of the stereoscopic display according to the entered image signal. Especially, this maybe most effective in a content in which 2D image signals and stereoscopic signals exist together.

According to the second object of the present invention, since the stereoscopic image display is used as a compatible display of 2D images and stereoscopic images, if difference in light volume in the 2D image display mode and in light volume in the stereoscopic image display mode that enters in the eyes of the observer is previously specified and the light volume to be entered in the eyes of the observer is controlled according to the display mode of the stereoscopic image display, when the display mode is switched, change created in the luminance can be kept at a minimum to eliminate flickers.

According to the third object of the present invention, if timing of switching the display mode of the stereoscopic image display is controlled, noise appeared on the screen of the stereoscopic image display can be prevented and confusion due to the incomplete display of stereoscopic images can be avoided to provide eye-friendly images during a time when the display mode is switched.

According to the fourth object of the present invention, if timing of switching the display mode of the stereoscopic image display is controlled, noise appearing on the screen of the stereoscopic image display can be prevented to provide eye-friendly images during a time when the display mode is switched.

According to the fifth object of the present invention, since display mode of the stereoscopic image display can be instantaneously switched to the 2D image display mode or the stereoscopic image display mode by using a simple structure without adding a new light source to the stereoscopic image display, switching can be completed within a period (blanking interval) where no image signal is displayed and prevent unwanted noise.

According to the sixth object of the present invention, when identifying signal is previously contained in the entered image signal, the identifying signal determines the signal to be either 2D image signal or stereoscopic image signal, the light source of the stereoscopic image display automatically controlling the display mode to switch to either the 2D image display mode or the stereoscopic image display mode. Observers do not need to switch the display mode by themselves. Especially, when the identifying signal is transmitted by inserting in the broadcasting signal and the like containing both 2D images and stereoscopic images, the identifying signal has an effect of automatically switching the display mode of the stereoscopic image display.

According to the seventh object of the present invention, even if the entered image signal does not contain any identifying signal, the display determines either 2D image signal or stereoscopic image signal by comparing the anteroposterior entered images and can automatically switch the image display mode of the stereoscopic display to either the 2D image display mode or the stereoscopic image display mode. Especially, it is efficient to automatically switch the display mode in enormous quantity of contents produced in the past in which 2D image signals and stereoscopic image signals exist together.

According to the eighth object of the present invention, since the anteroposterior images of the entered image signals are compared for more than twice, even if sudden change is produced in the image by noise or content editing, the display can prevent the display mode from switching by malfunction.

According to the ninth object of the present invention, since the light source for 2D images and the light source for stereoscopic images employ an integrated light source to change the illumination pattern for switching to either the 2D image display mode or the stereoscopic image mode, the light source is compact and can be switched at high speed, having an effect to reduce shadow and irregularity of light volume in comparison with conventional light sources with auxiliary light source.

According to the tenth object of the present invention, since the light source is materialized as an integrated compact type using the light source for both 2D image display and stereoscopic image display and the turn-on is controlled in a time-division manner, it enables to reduce power consumption. Moreover, if switching between the 2D image display mode and the stereoscopic image display mode is instantaneously performed, it has an effect to prevent shadow or irregularity of light volume.

According to the eleventh object of the present invention, if the light source is materialized in an integrated compact type using the light source for both 2D image display and stereoscopic image display and a LED array light source for stereoscopic image display is placed at the optical center of lens, it has an effect to prevent cross talk of stereoscopic image (leakage of left and right images) and to prevent shadow and irregularity of light volume in the 2D image display mode.

According to the twelfth object of the present invention, since the LED array light source for 2D image display has no polarization property, it has an effect to increase vertical resolution in the 2D image display mode and to extend the viewing range of the observer in the horizontal direction. Furthermore, turn-on of the light source in a time-division manner has an effect to reduce power consumption volume with keeping luminance.

According to the thirteenth object of the present invention, when 2D images are displayed, if the LED array light source for 2D images without polarization property is simultaneously turned on in addition to the LED array light source for stereoscopic images, vertical resolution in the 2D image display mode is not reduced to half and an effect is produced that luminance is increased by adding the light volume of the LED array light source for stereoscopic images and the LED array light sources for 2D images

According to the fourteenth object of the present invention, when 2D images are displayed, since the LED array light source for stereoscopic images is turned off and the light source for the LED array for 2D images is turned on, vertical resolution is not reduced to half, so that clear 2D image can be displayed.

### BRIEF DESCRIPTION OF THE DRAWINGS

FIG. 1 is an explanatory system view of a stereoscopic image display according to the embodiment 1 of the invention.

FIG. 2 is an explanatory view of a light source device for the stereoscopic image display according to the embodiment 1.

FIG. 3 is a perspective and explanatory view of the stereoscopic image display which schematic constitution is exploded.

FIG. 4 is an explanatory view showing a turn-on pattern of discrete type light source for the stereoscopic image display.

FIG. 5 is an explanatory view showing a placement example of light sources for 2D images and stereoscopic image of the stereoscopic image display.

FIG. 6 is an explanatory view showing an example of turn-on pattern in a time-division manner of discrete type light source for the stereoscopic image display.

FIG. 7 is an explanatory view showing an example of turn-on pattern in a time-division manner of light source of the stereoscopic image display.

FIG. 8 is an explanatory view showing a turn-on pattern of combined-use type light source for the stereoscopic image display.

FIG. 9 is an explanatory view showing a schematic constitution of the stereoscopic image display according to the embodiment 2 of the invention.

FIG. 10 is an explanatory view showing a turn-on pattern of light source for the stereoscopic image display.

FIG. 11A is a plan view of optical mechanism of a conventional stereoscopic image display, and FIG. 11B is an exploded, perspective view optical mechanism of a conventional other stereoscopic image display.

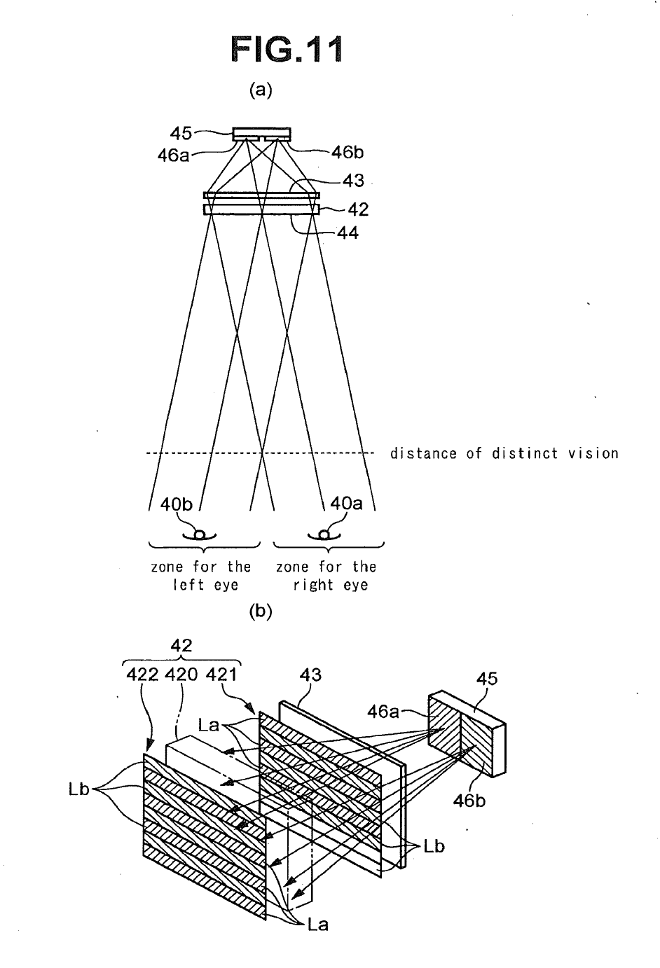

FIG. 12 is a stereoscopic image display without glasses that displays 2D images using the light source for stereoscopic images and the auxiliary light source placed backward.

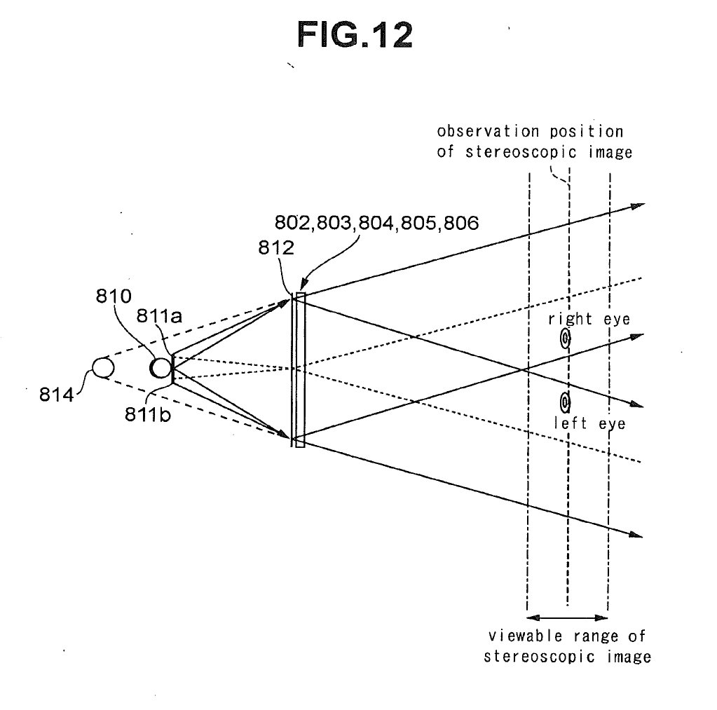

### EXPLANATION OF NUMERALS

51 identifying signal separation circuit
52 image separation memory circuit
53 image comparison circuit
54 2D-stereoscopic image determination circuit
55 light source drive circuit
56 stereoscopic image pair confirmation circuit
57 switch timing control circuit
58 2D-stereoscopic mode switching circuit
62, 92 liquid crystal display element
620 liquid crystal panel
63, 93 Fresnel lens
64, 94 diffuser
65R, 65L light source for stereoscopic images
66R polarization plate for the right eye
66L polarization plate for the left eye
67R, 67L light source for 2D images
71U, 71D LED array configuration
72U, 72D Polarization plate
80 observer
80R right eye
80L left eye
97R, 97L, 98R, 98L light source
98R LED light source array for extending view angle in the right direction
98L LED light source array for extending view angle in the left direction

### DISCLOSURE OF INVENTION

With view to the current situation, the present invention is made. The purpose is to provide quite a novel stereoscopic image display without glasses that the display mode of the stereoscopic image display is switched to either the 2D image display mode or the stereoscopic image display mode according to the entered image signal, automatically switching the image display mode not realized by conventional stereoscopic image display methods, eliminating shadow of the light source and/or luminance irregularity as a problem when 2D images are displayed, preventing deterioration of the vertical resolution, and making the observation position of the observer free.

In order to achieve the above purpose, a first object of the present invention is to provide a stereoscopic image display characterized in that an entered image signal is compared for determining whether the image signal is either a 2D image signal or a stereoscopic image signal and then an image display mode is switched to either a 2D image display mode or a stereoscopic image display mode.

A second object of the present invention is to provide a stereoscopic image display characterized in that luminance of the stereoscopic image display is controlled to make a same volume of light entering into the eyes of an observer in the 2D image display mode and the stereoscopic image display mode. In particular, it is to control the light volume of the light source and the contrast of liquid crystal display element.

A third object of the present invention is to provide a stereoscopic image display characterized in that a switch timing between the 2D display mode and the stereoscopic image display mode is controlled so as to be performed after a pair of the image signals for the left eye and the right eye of the stereoscopic image signal have been completed.

A fourth object of the present invention is to provide a stereoscopic image display characterized in that a switching timing between the 2D display mode and the stereoscopic image display mode is controlled so as to be performed within a blanking interval of an image synchronization signal.

A fifth object of the present invention is to provide a stereoscopic image display in which an optical means using an independent light source and a single focal length lens for the left and right eyes sorts an image to the left eye and the right eye of the observer to display, the stereoscopic image display, characterized in that an image display mode is switched to the 2D image display mode or the stereoscopic image display mode by changing an illumination pattern of a light source of the stereoscopic image display.

A sixth object of the present invention is to provide a stereoscopic image display according to the fifth object characterized in that either a 2D image signal or a stereoscopic image signal is determined by an identifying signal contained in the entered image signal and the image display mode of the stereoscopic display is switched to either the 2D image display mode or the stereoscopic image display mode by changing the illumination pattern of the light source of the stereoscopic image display.

A seventh object of the present invention is to provide a stereoscopic image display according to the fifth object, characterized in that either the 2D image signal or the stereoscopic image signal is determined by comparing the entered image signal and the image display mode of the stereoscopic image display is switched to either the 2D image display mode or the stereoscopic image display mode by automatically changing the illumination pattern of the light source of the stereoscopic image display.

A eighth object of the present invention is to provide a stereoscopic image display according to the fifth object, characterized in that the 2D image signal is determined to be either the 2D image signal or the stereoscopic image signal by comparing the entered image signal for more than twice and the image display mode of the stereoscopic image display is switched to either the 2D image display mode or the stereoscopic image display mode by automatically changing the illumination pattern of the light source of the stereoscopic image display.

A ninth object of the present invention is to provide a stereoscopic image display according to the fifth to eighth objects, characterized in that a commonly usable, integrated light source is used as the light source for 2D images and stereoscopic images and the illumination pattern of the light source is changed for responding to the 2D image display mode and the stereoscopic image mode

A tenth object of the present invention is to provide a light source device for stereoscopic image display according to the ninth object, having a form of LED arrays of two upper and lower rows with white LEDs or RGB LEDs tandemly arranged in the horizontal direction, the rows being equipped with polarization plates of different polarization property thereon respectively, in characterized in that the LED arrays of the two upper and lower rows are controlled to be alternately turned on right and left from an optical center in the stereoscopic image display mode whereas all LED arrays of the two upper and lower rows are turned on in the 2D image display mode.

A eleventh object of the present invention is to provide a light source device for stereoscopic image display according to the fifth to eighth objects, comprising a LED array light source for 2D images and a LED array light source for stereoscopic images having a form of LED arrays of two upper and lower rows with white LEDs or RGB LEDs tandemly arranged in the horizontal direction, characterized in that the LED array light source for stereoscopic images is placed at the optical center of a lens and the LED array light source for 2D images is placed in a same plane with the light source for stereoscopic images and a focal distance to be offset in the vertical direction.

A twelfth object of the present invention is to provide a light source device for stereoscopic image display according to the eleventh object, characterized in that the LED array light source for 2D images has not polarization property.

A thirteenth object of the present invention is to provide a stereoscopic image display according to the eleventh object, characterized in that in the 2D image display mode the light source device turns on the LED array light source for stereoscopic images and the LED array light source for 2D images.

A fourteenth object of the present invention is to provide a stereoscopic image display according to the eleventh object, characterized in that the light source device turns off the LED array light source for stereoscopic images and turns on the LED array light source for displaying 2D image.

In this description, the below terms shall be defined as follows.

1. Pair of Images for the Left Eye and Right Eye

A stereoscopic image signal comprises an image for the left eye and an image for the right eye, being an image signal that is originally shot by two lines simultaneously. When the image signal is transmitted via one line, it is required to transmit the image on a filed-to-field or a frame-to-frame basis of image signal (right to left to right to—to be continued—) in sequence. Stereoscopic image signal always consists of pair of an image signal for the right eye and an image signal for the left eye.

2. Vertical Blanking Interval

It means a period that the video signal is not displayed on the screen at the vertical synchronization.

3. Time-Division Turn-On

Most simple methods for turning on and control white LEDs and the like are a direct-current turn-on which the light turns on when direct current voltage is given and current is applied and a pulse turn-on which a current of some times larger than the direct-current turn-on is applied for a short period for driving. The turn-on of the present invention in a time-division manner means that the turn-on position (pattern) and turn-on time of LEDs are simultaneously controlled by driving the pulse turn-on to show the human eyes as if all of the white LEDs were turned on, but that individual white LEDs are driven in a time-division manner. In other expression, some of white LEDs are always turned on and driven with the time shared.

4. VBI

It is an abbreviation of Vertical Blanking Interval, meaning a vertical blanking period of video signal.

5. Identifying Signal

It means an identifying signal for applying to the display or record reproduction by inserting into an image signal information of stereoscopic image signal, for example, field sequential, division into left and right, division into upper and lower, parallel L, parallel R, line sequential or normal (2D image signal) and the like.

6. LED Array

It means that circle or square white LEDs or RGB LEDs are linearly arranged in the horizontal direction.

7. Cross Talk of Stereoscopic Image

When an image simultaneously enters into the right eye and the left eye of the observer, for example, when the image for the left eye leaks and enters into the right eye of the observer, it is called cross talk. Less the cross talk is, better the quality of the stereoscopic image becomes and better the observer views.

8. Stereoscopic Image Display According to the Frame Sequential Method

It is a method of stereoscopic image display or a method of displaying an image for the right eye and an image for the left eye alternately at slightly different times. Since the image is not divided into line and the like, it is called a frame sequential method. Or, since the image is displayed at slightly different times, it is called a time-division method or a shutter method as well.

### DESCRIPTION OF THE PREFERRED EMBODIMENTS

Now, embodiments of the present invention will be described by referring to the accompanying drawings.

The below described arrangement is merely illustrative of the preferred embodiments of the invention but with preferred various limits in view of technology. It is to be expressly understood that the scope of the invention is not intended as a definition of the limits of the invention unless stated.

### Embodiment 1

In this embodiment of the present invention, there is described a method of determining 2D image signal and stereoscopic image signal by the stereoscopic image display without glasses and controlling light source when the display mode is switched.

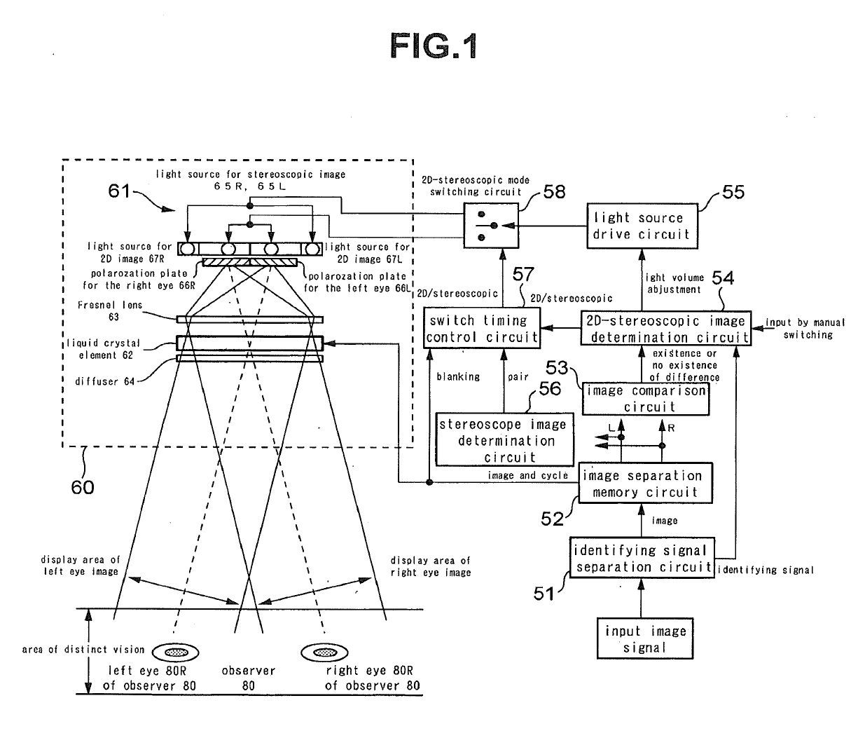

As shown in FIG. 1, in the stereoscopic image display of the present invention, an entered image signal comprises an identifying signal separation circuit 51 which separates identifying signal contained in the entered image signal, an image separation memory circuit 52 which separates and stores when the entered image signal does not contain any identifying signal, an image comparison circuit 53 for comparing immediate pre-image and current image to determine an existence or non-existence of difference, a 2D-stereoscopic image determination circuit 54 which receives an identifying signal and a signal showing existence or non-existence of difference, determining the entered image signal to be either 2D image or stereoscopic image, a light source drive circuit 55 which coordinates light sources for stereoscopic images 65R and 65L or light sources for 2D images 67R and 67L and light sources for stereoscopic images 65L and 65R to drive turn-on, a stereoscopic image pair confirmation circuit 56 which supervises a pair of images for the left and right eyes of stereoscopic image and confirms completion of pair images, a switch timing control circuit 57 which controls switch timing of the light source, and a 2D-stereoscopic mode switching circuit 58 which receives signal from the switch timing control circuit 57, finally switching the illumination pattern of the light source.

The stereoscopic image display 60 is integrally constituted of light sources for stereoscopic image display 65R and 65L and light sources for 2D image display 67R and 67L, switching the display mode of the stereoscopic image display by changing illumination pattern of the light source.

At the same time when the display mode is switched, the entered image signal is converted into the display mode of the stereoscopic image display and fed to the liquid crystal display element 62, thus the observer can view stereoscopic images and 2D images on the same stereoscopic image display.

Here, there is described under the assumption that mode of the image signal entered into the stereoscopic image display of the present invention is unknown.

First, there is described a case that an entered image signal contains some identifying signal.

For example, if the image signal contains an ID signal using VBI according to CPR-1204 of EIAJ as above shown, the identifying signal separation circuit 51 separates the identifying signal contained in the VBI portion of the image signal and transmits the identifying signal to the 2D-stereoscopic determination circuit 54 for determining the signal to be either stereoscopic image or 2D image. In the case that the determination results in the stereoscopic image, after the stereoscopic image pair confirmation circuit 56 has confirmed pairs have been completed, when timing is adjusted within blanking interval to switch the switch timing control circuit 57 of the 2D-stereoscopic mode to the stereoscopic image mode and turn on the light sources for stereoscopic images 65R and 65L, an observer 80 can view stereoscopic image displayed on the liquid crystal panel 62. In the stereoscopic image display mode, the light sources 67R and 67L are turned off.

In the case that determination by the 2D-stereoscopic image determination circuit 54 results in 2D image, the determined signal is transmitted to the light source drive circuit 55 to coordinate light volume of the light sources for stereoscopic images 65R and 65L and the light sources for 2D images 67R and 67L. The purpose is to provide the observer 80 with easily viewable 2D images by adjusting the light volume entered in the observer 80 to the same volume in the 2D image display mode and the stereoscopic image display mode.

Example in FIG. 1 shows that a polarization plate 66R and a polarization plate 66L are placed in front of the light sources for stereoscopic images 65R and 65L but no polarization plate is placed in front of the light sources for 2D images 67R and 67L. In addition, in the 2D image mode, the light sources for stereoscopic images 65R and 65L and the light sources for 2D images 67R and 67 are simultaneously turned on. In this case, since the light that arrives at the observer 80 produces difference in volume, adjustment of the light volume is required. The adjustment of the light volume provides an easier viewing of 2D images and prevents sudden change in luminance or of flickers when the stereoscopic image display mode is switched to the 2D image display mode

Not only adjustment of light volume of light source but also fine correction of difference in light volume by parallely controlling contrast of liquid crystal display element can be performed.

Furthermore, the 2D-stereoscopic image determination circuit 54 sends a signal showing 2D image to the switch timing control circuit 57. After the stereoscopic image pair confirmation circuit 56 has confirmed completion of pair of stereoscopic images that have been shown up to then, the 2D-stereoscopic mode switching circuit 58 is switched to the 2D mode in synchronization with the timing of blanking interval, and the light sources for stereoscopic images 65R and 65L and the light sources for 2D images 67R and 67L are simultaneously turned on. Then, the observer 80 can view 2D images displayed on the liquid crystal panel 62. As will be described hereinafter, the reason is that 2D images can be viewable when the light sources for 2D images 67R and 67L are turned on (the description is omitted here).

This stereoscopic image mode is switched to the 2D image mode when complete display of left and right images is confirmed on the stereoscopic image display. Therefore, for example, it prevents that only image for the right eye is displayed and left and right images are incompletely displayed in the stereoscopic image display mode. Furthermore, adjustment of switching the display mode in blanking interval prevents noise at switching from appearing on the display screen.

There will now be described a case that an entered image signal has not identifying signal.

The entered image signal, in which the identifying signal separation circuit 51 detects no identifying signal, is transmitted to the image separation memory circuit 52 where the entered image signal is separated in a stored image and a current image and then transmitted to the left and right images comparison circuit 53. The image comparison circuit 53 compares, for example, the immediate pre-image to the current image to detect any existence of difference. In the case of 2D images, the image for the right eye and the image for the left eye have the same image signal and cause no difference when they are compared. In the case of stereoscopic images, since the image for the left eye and the image for the right eye are different images due to the distant location between the left eye and the right eye, it is sure that difference is produced when they are compared.

Existence or non-existence of difference facilitates to determine whether a signal is for 2D image or for stereoscopic image. Of course, in this embodiment, an immediate pre-image and a current image are compared, but a current image may be compared to a post-image or every plurality of images may be compared.

When existence or non-existence of difference is transmitted to the 2D-stereoscopic image determination circuit 54, if any difference exists, the signal is a stereoscopic image signal. After the stereoscopic image pair confirmation circuit 56 completed confirmation of pair images, the switch timing control circuit 57 synchronizes the signal with a blanking interval and adjusts the final timing to switch the 2D-stereoscopic mode switching circuit 58 to the stereoscopic mode and to turn on the light sources for stereoscopic images 65L and 65R. The observer 80 can view a stereoscopic image displayed on the liquid crystal panel 62 accordingly.

If no difference exists, the 2D-stereoscopic image determination circuit 54 transmits a signal showing 2D image to the stereoscopic image pair confirmation circuit 56 in which stereoscopic images displayed until now are confirmed to have completed in pairs. The 2D-stereoscopic mode switching circuit 58 is switched to the 2D mode. The light sources for stereoscopic images 65L and 65R and the light sources for 2D images 67L and 67R are turned on. The observer 80 can view a 2D image displayed on the liquid crystal panel 62.

Furthermore, the 2D-stereoscopic image determination circuit 54 has a function of determining 2D image and stereoscopic image which verifies existence or non-existence of difference for plural times, if required, and prevents the stereoscopic image mode and the 2D image mode from being switched to each other due to noise contained in the entered image signal or extraneous noise.

The 2D image determination signal is transmitted to the light source drive circuit 55 to adjust the light volumes of light sources for stereoscopic images 65L and 65R and the light sources for 2D images 67R and 67L.

When a volatile 2D image signal is entered, difference may be produced in between the stored immediate pre-image and the current image. But, since difference by disparity is not produced on the whole screen as in the case of the stereoscopic image, a plurality of detection and control of threshold as a volume of difference prevent malfunction due to the volatile 2D image signal. Furthermore, if memory volume is increased, when a plurality of fields or frame images are compared, more volatile images can be responded. Moreover, since change in editing point by content editing is stronger than the volume of disparity between let and right images of stereoscopic image, control of threshold as a volume of difference can prevent malfunction as well.

There will now be described a case in which an observer manually switches the image display mode irrespective of the entered image signal.

The 2D-stereoscopic image determination circuit 54 receives an entry which the observer manually switch the image display mode by their wills. The entered signal in this way initiates the 2D-stereoscopic image determination circuit 54 to transmit a control signal for switching to either the 2D image mode or the stereoscopic image mode to the switch timing control circuit 57. After the stereoscopic image pair confirmation circuit 56 has confirmed completion in pairs, the switch timing control circuit 57 synchronizes the signal with a blanking interval and the 2D-stereoscopic mode switching circuit 58 transmits the control signal to the light source drive circuit 55 to switch the display mode.

In the case that the image display mode is manually switched, the switch timing control circuit 57 adjusts switch timing and the light source drive circuit 55 adjusts the light volume. Observers can view an image without noise due to switching between the stereoscopic image mode and the 2D image mode or without change in luminance. Switching by the observer can be controlled by using an external device or a remote controller.

There will now be described a mechanism of stereoscopic image display and 2D image display by the stereoscopic image display of the embodiment.

FIG. 1 shows a stereoscopic image display of the embodiment 1. In this figure, numeral 62 shows a liquid crystal display element, and Fresnel lens 63 is placed on the backside of the liquid crystal display element 62 with keeping a prescribed distance. This Fresnel lens 63 has concave-convex lens surface which is placed for ejecting the entered light from the focal point of the center of the backside of the Fresnel lens as a substantially parallel light, having a function for dividing the image to the left and right eyes of the observer 80.

Front face of the liquid crystal display element 62 is equipped with a diffuser 64 with property of diffusing only in the vertical direction. The light transmitted through the liquid crystal display element 62 is ejected onto the observer side via the diffuser 64 and is used for extending the vision in the longitudinal direction.

In FIG. 1, numeral 61 shows an integrated light source for 2D images and stereoscopic images for irradiating the liquid crystal display element 62 from the backside.

In this embodiment 1, the light source is constituted of the light sources for stereoscopic images 65R and 65L and the light sources for 2D images 67R and 67L which are tandemly arranged in row in the horizontal direction, further constituted of white LEDs which are divided into blocks for controlling individual turn-on on either side of the optical center. EL elements which are as same as white LEDs and RGB LEDs can be applied. In this embodiment 1, round shape LEDs are applied, but stick shape LEDs which are integrated per square shape or block can be applied.

There will now described that a mechanism for displaying a stereoscopic image.

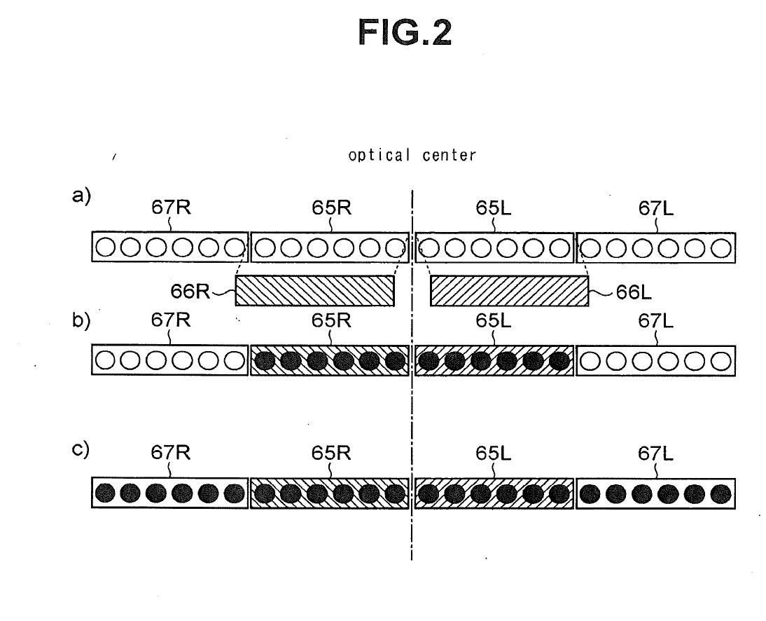

In the stereoscopic image display mode, the light source 65R and the light source 65L are turned on, as shown in FIG. 2B.

In this description, black circle “•” shows that LEDs are turned on. The light source 65R is light source for the right eye area of the observer. The light source 65L is light source for the left eye area of the observer.

A polarization plate for the right eye 66R and a polarization plate for the left eye 65L are placed on the front side (irradiation side) of the light sources 65R and 65L, respectively.

These polarization plate for the right eye 66R and polarization plate for the left eye 65L are constituted as a linear polarization plate where polarization directions orthogonally intersect to each other. For example, they form a right upward polarization plane and a left upward polarization plane. The same effect is created in the vertical direction and in the horizontal direction. Furthermore, if polarization property is given to LEDs per se, polarization plate can be omitted. Moreover, a circular polarization plate with different rotation direction can be used.

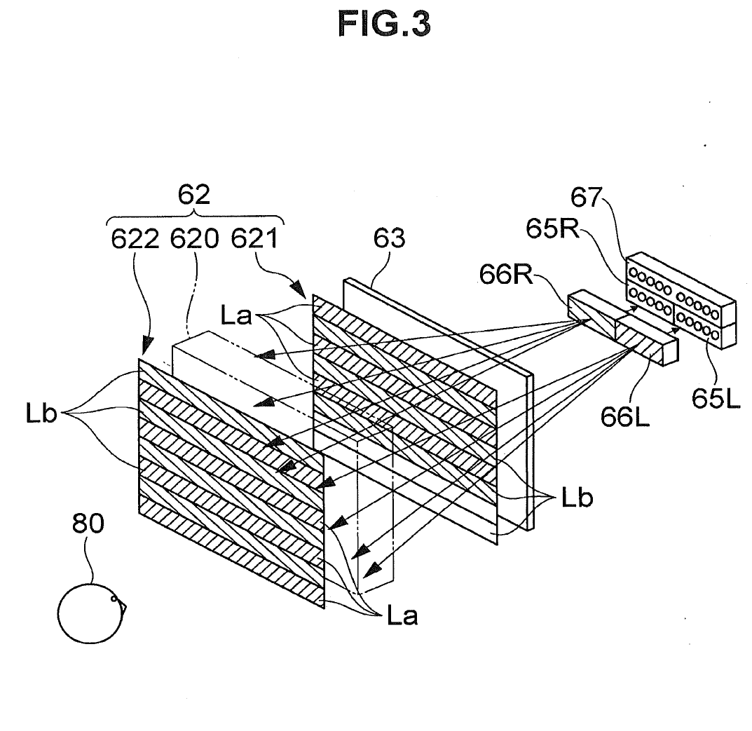

The liquid crystal display element 62 is a light transmission type. As shown in FIG. 3, two sheets of polarization plates 621 and 622 having the same property as the polarization plate for the light source are placed on both sides of the liquid crystal panel 620 where the liquid crystal display element 62 is arranged.

The liquid crystal panel 620 houses, for example, 90-degree twisted liquid crystals in a pair of alignment films, emitting the entered light with 90-degree turn when power voltage is not applied to between the pair of alignment films, and emitting the entered light without change when power voltage is applied. Two sheets of polarization plates 621 and 622 have linear polarization plate line portions La and Lb at right angles to each other alternately placed on per horizontal line of the liquid crystal panel, respectively. The linear polarization plate line portions La and Lb opposed to the light source (back side) and the observer side (front side) are arranged at right angles to each other in the polarization direction.

In the example of the liquid crystal display element 62 shown in FIG. 3, two sheets of the polarization plates 621 and 622 are placed on both sides of the liquid crystal panel 620 and the linear polarization plate line portions La and Lb at right angles to each other are alternately arranged per horizontal line of the liquid crystal panel. In view of costs, as a respective polarization plate is used a linear polarization plate with the same polarization plane where polarization angles of the both polarization plates are set at right angles to each other. In this case, if ½ wavelength sheet is placed on the polarization plate of the backlight light source side per every other horizontal line of the liquid crystal panel 620, the same effect may be obtained.

Therefore, since the light from a polarization plate for the right eye 66R or a polarization plate for the right eye 66L placed as a light source enters only from the linear polarization plate line portions La and Lb that correspond the polarization direction and are on the same polarization side, the light enters every other horizontal line respectively. The respective entered lights are transmitted when no power voltage is given and shut off when power voltage is given.

Furthermore, the liquid crystal panel 620 of the liquid crystal display element 62 is constituted so as to alternately display information of images for the right eye and the left eye per horizontal line in accordance with the transmitted lines from two sheets of the polarization plates 621 and 622, so if the observer 80 views the liquid crystal display element 62 in a distinct vision area, only image for the right eye enters into the right eye 80R of the observer 80 and only image for the left eye enters into the left eye 80L, respectively and separately. In this way, stereoscopic image can be viewed by stereoscopic perception of the both eyes.

There will now be described a mechanism displaying 2D images

In the 2D image display mode as shown in FIG. 2C, the light source 67R, the light source 67L and the light sources for stereoscopic images 65R and 65L are simultaneously turned on.

No polarization plate is placed on the front side (irradiation side) of this light source for 2D images 67R, so the light has no polarization property. Since the light transmits all the two sheets of the polarization plates 621 and 622 on the liquid crystal panel 620 of the liquid crystal display element 62, information of images for the right eye and the left eye are simultaneously displayed.

Therefore, if the observer 80 views the liquid crystal display element 62, the observer 80 can see the same image on both image display areas for the right eye and area for the left eye.

On this occasion, since information of images for the right eye and the left eye are not alternately displayed per horizontal line as when stereoscopic images are displayed, vertical resolution of 2D image signals is not reduced to half and observers can see 2D images displayed on the horizontal line. Furthermore, observers with restriction of movement in left and right directions when stereoscopic images are displayed can move freely and view 2D images in full resolution without taking the observation position into account.

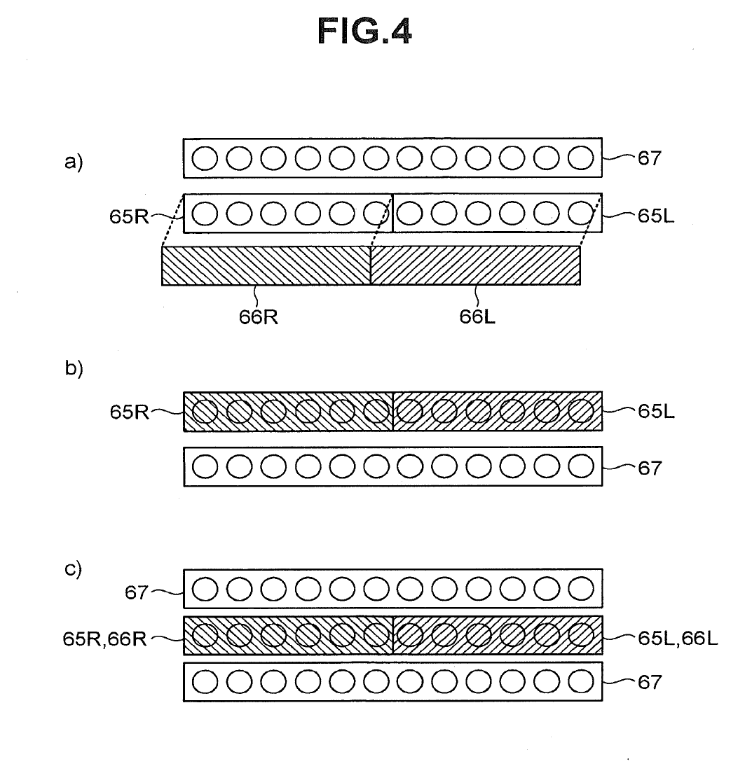

In the above explanation, we described a combination of the light sources for 2D images 67R and 67L and the light sources for stereoscopic images 65L and 65R, but the constitutions shown in FIGS. 4A, B and C have the same effect.

The example shown in FIG. 4 is constituted so that the light source 65R and the light source 65L are turned on in this stereoscopic image display mode and the light source 67 is turned on in the 2D image display mode.

The light source 65R is light source for the right eye area of the observer 80 whereas the light source 65L is light source for the left eye area of the observer 80. Polarization plate for the right eye 66R and polarization plate for the left eye 66L are placed on the front side (irradiation side) of the light sources 65R and 65L, respectively.

Therefore, if the observer views the liquid crystal display element 62 from distance of distinct vision, only image for the right eye enters into the right eye 80R of the observer 80 and only image for the left eye enters into the left eye 80L independently, so that the observer can recognize the image as a stereoscopic image.

Furthermore, in the 2D image display mode, the light source 67 is turned on. Since no polarization plate is placed on the front side (irradiation side) of the light source for 2D images 67, the light transmits through all the two sheets of polarization plates 621 and 622 on the liquid crystal panel 620 of the liquid crystal display element 62 and information of images for the right eye and the left eye are simultaneously displayed. Observers can accordingly view the images as 2D images.

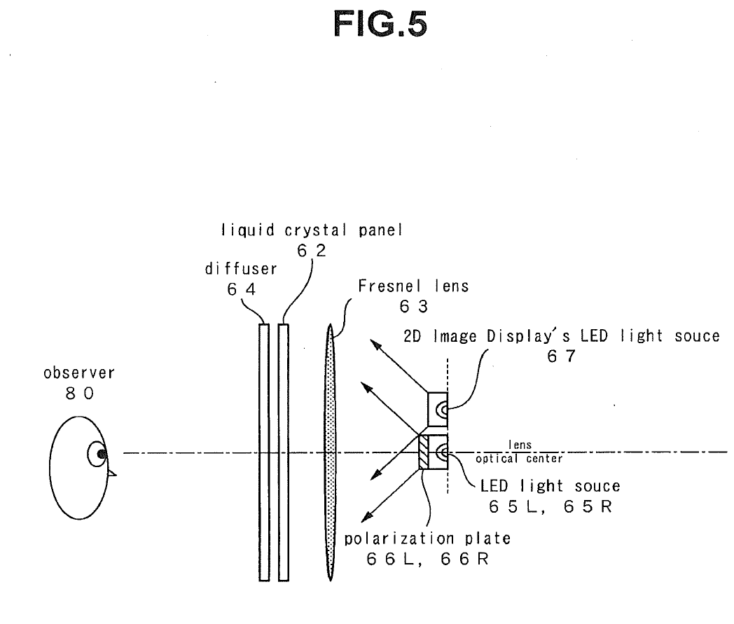

Furthermore, as arrangement of light source shown in FIG. 5, in the example using the light source of FIG. 4A, the light sources for stereoscopic images 65L and 65R and the light sources for 2D images 67 are placed at the optical center of the Fresnel lens 63 whereas the light source for 2D images 67 is not placed behind the light sources for stereoscopic images 65L and 65R and offset in the vertical direction from the optical center of the Fresnel lens 63. This placement does not produce any shadow due to superimposing either of the light sources for stereoscopic images 65L and 65R and the light source for 2D images 67 on the other of the light sources for stereoscopic images 65L and 65R and the light source for 2D images 67, reducing cross talk (leakage of left and right images) when stereoscopic images are displayed, and providing stereoscopic images with higher resolution.

Furthermore, since the images entered into the right eye and the left eye are the same in the 2D image display mode, offset of the light source in the vertical direction does not influence on cross talk.

In examples shown in FIGS. 4B and C, the light sources for stereoscopic images 65L and 65R are placed at the optical center of the Fresnel lens 63; whereas the light sources for 2D images 67 are not placed on the backside of the light sources for stereoscopic images 65L and 65R and offset into the vertical direction from the optical center of the Fresnel lens 63. In this manner, the same effect can be obtained.

There will now be described a method of reducing power consumption of light source when 2D images are displayed. Light source shown in FIG. 4A is taken as an example.

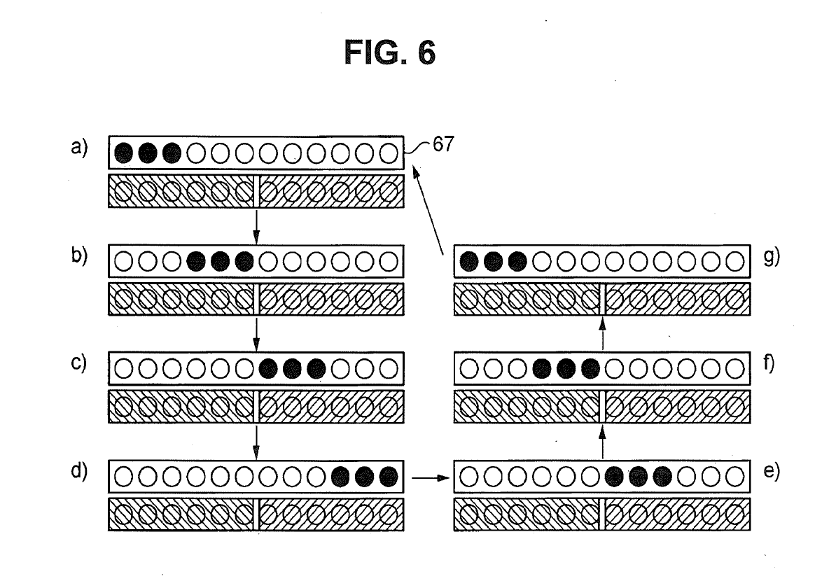

As shown in FIG. 6, using a part (three pieces in this example) of LEDs of the light source for 2D images 67 when 2D images are displayed, turn-on positions in the order of A to B to C to D to E to F to G to A are controlled in a time-division manner at high speed. In this way, the same view angle as the situation when all light sources are turned on can be secured simultaneously with reduction of power consumption of light source. In the figure, black circle “•” shows that LED is turned on.

This embodiment shows an example of a simultaneous control of three LEDs, but the number of turned on LEDs may be changed according to the luminance required for the image display. The order of turn-on such as A to B to C to D to E to F to G to A does not influence upon the effect.

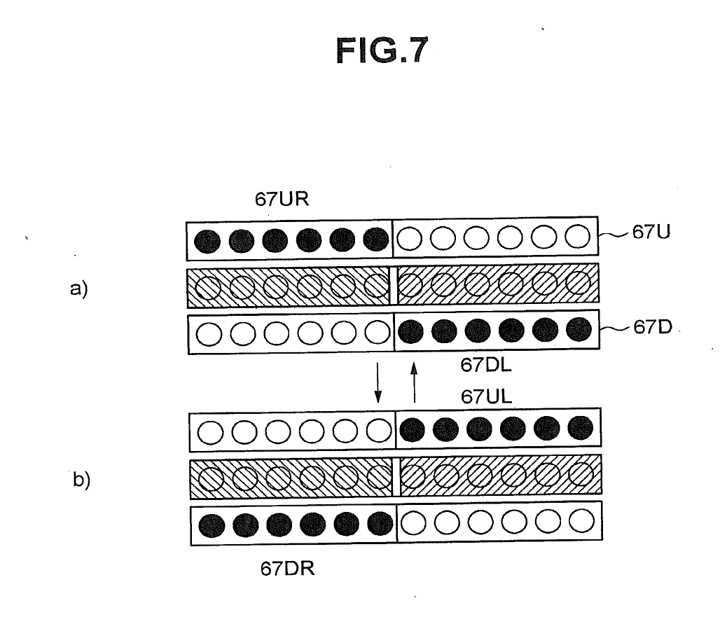

Furthermore, FIG. 7 shows another method for reducing power consumption of light source when 2D images are displayed. Light source is described using constitution of FIG. 4C as an example.

In this example, there are provided a plurality of light sources for 2D images 67U and 67D. Simultaneous turn-on of light sources for 2D images 67UR and 67DL shown in FIG. 7A and simultaneous turn-on of light sources for 2D images 67UL and 67DR shown in FIG. 7B are alternately switched at high speed in a time-division manner without interruption. So, power consumption of the light sources can be reduced. In the figure, black circle “•” shows that LED is turned on.

Control shown in FIG. 6 and control shown in FIG. 7 can be combined.

Current light source devices are integrated, but the description is made on the embodiment of controlling the pattern in which the light source for 2D images and the light source for stereoscopic images are separately illuminated.

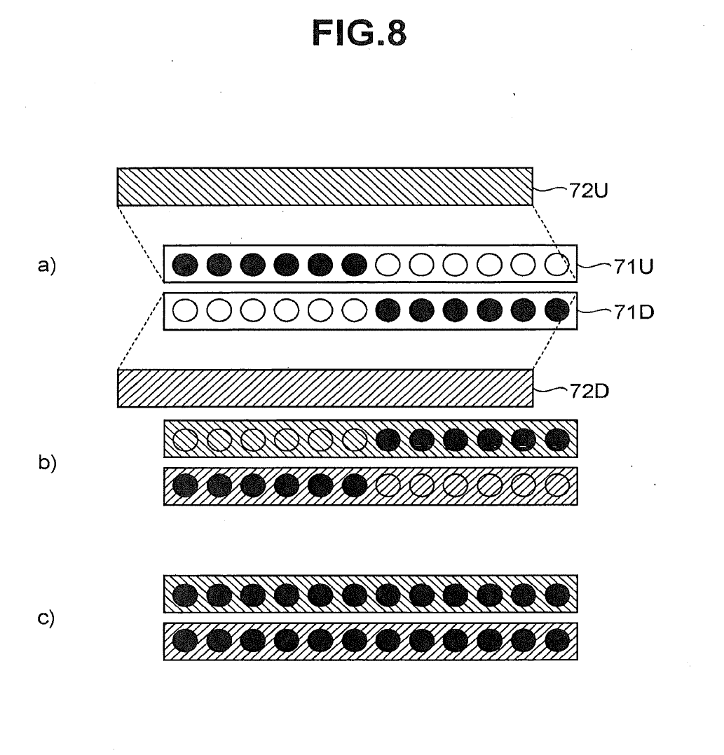

In FIG. 8 there will now be described an embodiment of an integrated light source sharing a light source for 2D images and a light source for stereoscopic images.

FIG. 8 shows an example. The light source is constituted of two rows of LED array configurations 71U and 71D on which white LEDs or RGB LEDs are tandemly arranged in the horizontal direction. Polarization plates 72U and 72D with 90-degree different polarization property are placed on each row respectively. In the figure, black circle “•” shows that LED is turned on.

In this example, LED arrays of two upper and lower rows are alternately turned on either side of the center in the stereoscopic image display mode. As shown in FIG. 8C, in the 2D image display mode, turn-on patterns are changed in order to turn on LED arrays of two upper and lower rows, so that the same effect is obtained as when the light source for 2D images and the light sources for stereoscopic images are separated.

Furthermore, even if the turn-on pattern is changed to that shown in FIG. 8B, the left and right images are reversed, but it is as same as the turn-on pattern in the stereoscopic image display mode.

Moreover, switching of illumination pattern shown in FIGS. 8A and B can be applied as a switching pattern when the left and right images of stereoscopic image signal are reversed.

In this way, the turn-on of the light source described in this embodiment 1 uses LEDs or ELs. Therefore, the light sources are different from the light sources for stereoscopic image display with conventional fluorescent tube or lump. Since switching or turn-on/off can be performed at high speed, turn-on time or partial turn-on can be done in a time-division manner. Control of turning on the light source for 2D images and the light sources for stereoscopic images in a time-division manner can reduce power consumption to a considerable extent.

In this embodiment 1, entered stereoscopic image signals are described under assumption that they are applied to TV broadcasting. Signals such as DVD disks recorded with contents or camera images, stereoscopic images such as animation created by still image digital camera or computer, and computer graphics (CG equipment) may be entered signal.

Furthermore, two-group signals with right and left images, respectively, in either group may be utilized instead of using stereoscopic signals in which right and left images are synthesized in a group.

### Embodiment 2

Embodiment 2 will describe an example that this invention is applied to a stereoscopic image display without glasses using frame sequential method.

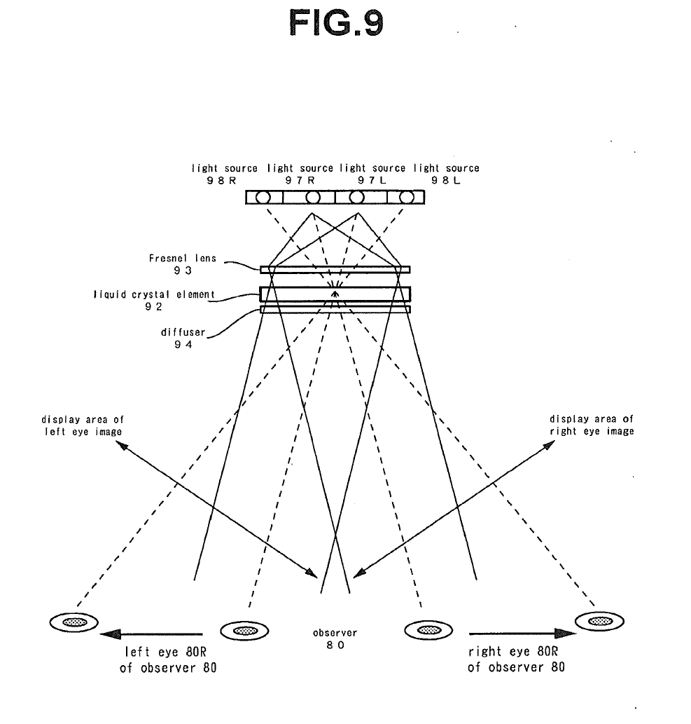

In FIG. 9, numeral 92 is liquid crystal display element. The Fresnel lens 93 is placed on the backside of the liquid crystal display element 92 away at a prescribed distance. The Fresnel lens 93, having a concave-convex lens face, is placed for emitting the entered light from the central focal point of the backside of the Fresnel lens 93 as a substantially parallel light and has a function of dividing the image into the right and left eyes of the observer 80.

A diffuser 94 diffusing the light only in the vertical direction is equipped on the front of the liquid crystal display element 92. The light transmitted through the liquid crystal display element 92 is emitted via the diffuser 94 to the observer side, so it is used for extending the view range in the longitudinal direction.

Moreover, in FIG. 9, numerals 97R, 97L, 98R and 98L are light sources for irradiating the liquid crystal display element 92 from the backside.

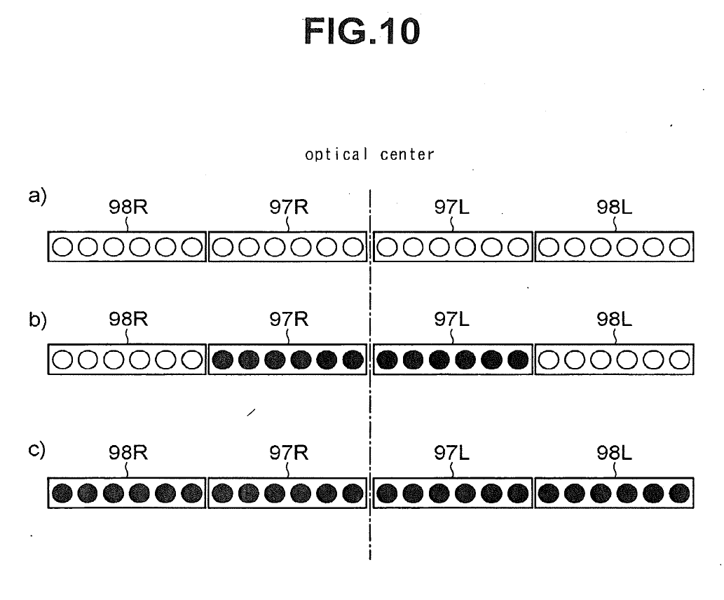

As shown in FIG. 10A of this embodiment, the light source is constituted of light sources for stereoscopic images 97R and 97L and light sources for 2D images 98R and 98L, which are further constituted of white LEDs or RGB LEDs divided in blocks that can control individual turn-on.

There will first be described a mechanism of displaying stereoscopic image.

As shown in FIG. 9, the light sources 97R and 97L are placed on either side of the optical center of the Fresnel lens 93. The light source for the right eye 97R and the light source for the left eye 97L are placed from the center, respectively. The light source 97R as backlight is light source for the right eye area of the observer whereas the light source block 97L as backlight is light source for the left eye area of the observer.

These light source 97R and light source 97L are constituted for being alternately turned on per frame or field of image signal for the right eye and image signal for the left eye.

Furthermore, the liquid crystal display element 92 is light transmission type. On both sides of liquid crystal panel on which the liquid crystal display element 92 is placed, two sheets of polarization plates as described in the embodiment 1 are not placed, but liquid crystal display element 92 is constituted so as to alternately display information of images for the right eye and for the left eye per frame or field of image signal frame-sequentially in a time-division manner.

Synchronizing these two operations enables only image for the right eye to enter into the right eye 80R of the observer 80 and only image for the left eye to enter into the left eye 80L of the observer 80 respectively and separately when the observer 80 views the liquid crystal display element 92. Therefore, the observer 80 can view the image as a stereoscopic image by the three-dimensional perception based on binocular parallax.

In this case, information of images for the right eye and the left eye are alternately displayed at a refresh rate of more than 50 to 60 times per second so that human eyes do not see any flicker.

There will now be described a mechanism of displaying 2D image in the embodiment 2.

As shown in FIG. 10C of this embodiment 2, all the light sources 98R, 98L, 97R and 97L are turned on when 2D images are displayed, so that the observer 80 can view the image as a 2D image. On this occasion, it is not necessary to alternately display information of images for the right eye and for the left eye as when stereoscopic images are displayed, so that permanent turn-on of the light source or blinking of the light source at high speed can reduce flickers.

As shown in FIG. 10, since LED light source arrays for extending view angle in the right direction 98R and LED light source arrays for extending view angle in the left direction 98L are additionally placed on the right and left sides of the light sources for stereoscopic images 97R and 97L and turned on in conjunction with the 2D image display mode, right and left view angles can be extended to a considerable extent when 2D images are displayed. Switching turn-on of the LED light source at high speed in a time-division manner without interruption may reduce power consumption of the light source.

As shown in FIG. 10A of the embodiment 2, the light source is constituted as an integrated type. In the stereoscopic image display mode, turn-on pattern as shown in FIG. 10B is employed. In the 2D image display mode, turn-on pattern as shown in FIG. 10C is employed. Image display mode of the stereoscopic image display can be switched in this manner.

Determination between 2D image signal and stereoscopic image signal as well as control of light source are as same as those of the embodiment 1. Detailed description is omitted here accordingly.

1. A stereoscopic image display, characterized in that an entered image signal is compared for determining whether the image signal is either a 2D image signal or a stereoscopic image signal and then an image display mode is switched to either a 2D image display mode or a stereoscopic image display mode.

2. (canceled)

3. A stereoscopic image display, characterized in that a switch timing between a 2D display mode and a stereoscopic image display mode is controlled so as to be performed after a pair of the image signals for the left eye and the right eye of the stereoscopic image signal have been completed.

4. (canceled)

5. A stereoscopic image display without glasses in which an optical means using an independent light source and a single focal length lens for the left and right eyes sorts an image to the left eye and the right eye of the observer to display, the stereoscopic image display, characterized in that an image display mode is switched to a 2D image display mode or a stereoscopic image display mode by changing an illumination pattern of a light source of the stereoscopic image display.

6. A stereoscopic image display according to claim 5, characterized in that either a 2D image signal or a stereoscopic image signal is determined by an identifying signal contained in the entered image signal and the image display mode of the stereoscopic display is switched to either the 2D image display mode or the stereoscopic image display mode by changing the illumination pattern of the light source of the stereoscopic image display.

7. A stereoscopic image display according to claim 5, characterized in that either the 2D image signal or the stereoscopic image signal is determined by comparing the entered image signal and the image display mode of the stereoscopic image display is switched to either the 2D image display mode or the stereoscopic image display mode by automatically changing the illumination pattern of the light source of the stereoscopic image display.

8. A stereoscopic image display according to claim 5, characterized in that the 2D image signal is determined to be either the 2D image signal or the stereoscopic image signal by comparing the entered image signal for more than twice and the image display mode of the stereoscopic image display is switched to either the 2D image display mode or the stereoscopic image display mode by automatically changing the illumination pattern of the light source of the stereoscopic image display.

9. A stereoscopic image display according to claim 5, characterized in that a commonly-usable, integrated light source is used as the light source for 2D images and stereoscopic images and the illumination pattern of the light source is changed for responding to the 2D image display mode and the stereoscopic image mode.

10. A light source device for stereoscopic image display according to claim 9, having a form of LED arrays of two upper and lower rows with white LEDs or RGB LEDs tandemly arranged in the horizontal direction, the rows being equipped with polarization plates of different polarization property thereon respectively, in characterized in that the LED arrays of the two upper and lower rows are controlled to be alternately turned on right and left from an optical center in the stereoscopic image display mode whereas all LED arrays of the two upper and lower rows are turned on in the 2D image display mode.

11. A light source device for stereoscopic image display according to claim 5, comprising a LED array light source for 2D images and a LED array light source for stereoscopic images having a form of LED arrays of two upper and lower rows with white LEDs or RGB LEDs tandemly arranged in the horizontal direction, characterized in that the LED array light source for stereoscopic images is placed at the optical center of a lens and the LED array light source for 2D images is placed in a same plane with the light source for stereoscopic images and a focal distance to be offset in the vertical direction.

12. A light source device for stereoscopic image display according to claim 11, characterized in that the LED array light source for 2D images has not polarization property.

13. A stereoscopic image display according to claim 11, characterized in that in the 2D image display mode the light source device turns on the LED array light source for stereoscopic images and the LED array light source for 2D images.

14. A stereoscopic image display according to claim 11, characterized in that the light source device turns off the LED array light source for stereoscopic images and turns on the LED array light source for displaying 2D image.

15. A stereoscopic image display according to claim 6, characterized in that a commonly-usable, integrated light source is used as the light source for 2D images and stereoscopic images and the illumination pattern of the light source is changed for responding to the 2D image display mode and the stereoscopic image mode.

16. A stereoscopic image display according to claim 7, characterized in that a commonly-usable, integrated light source is used as the light source for 2D images and stereoscopic images and the illumination pattern of the light source is changed for responding to the 2D image display mode and the stereoscopic image mode.

17. A light source device for stereoscopic image display according to claim 15, having a form of LED arrays of two upper and lower rows with white LEDs or RGB LEDs tandemly arranged in the horizontal direction, the rows being equipped with polarization plates of different polarization property thereon respectively, in characterized in that the LED arrays of the two upper and lower rows are controlled to be alternately turned on right and left from an optical center in the stereoscopic image display mode whereas all LED arrays of the two upper and lower rows are turned on in the 2D image display mode.

18. A light source device for stereoscopic image display according to claim 16, having a form of LED arrays of two upper and lower rows with white LEDs or RGB LEDs tandemly arranged in the horizontal direction, the rows being equipped with polarization plates of different polarization property thereon respectively, in characterized in that the LED arrays of the two upper and lower rows are controlled to be alternately turned on right and left from an optical center in the stereoscopic image display mode whereas all LED arrays of the two upper and lower rows are turned on in the 2D image display mode.

19. A light source device for stereoscopic image display according to claim 6, comprising a LED array light source for 2D images and a LED array light source for stereoscopic images having a form of LED arrays of two upper and lower rows with white LEDs or RGB LEDs tandemly arranged in the horizontal direction, characterized in that the LED array light source for stereoscopic images is placed at the optical center of a lens and the LED array light source for 2D images is placed in a same plane with the light source for stereoscopic images and a focal distance to be offset in the vertical direction.

20. A light source device for stereoscopic image display according to claim 7, comprising a LED array light source for 2D images and a LED array light source for stereoscopic images having a form of LED arrays of two upper and lower rows with white LEDs or RGB LEDs tandemly arranged in the horizontal direction, characterized in that the LED array light source for stereoscopic images is placed at the optical center of a lens and the LED array light source for 2D images is placed in a same plane with the light source for stereoscopic images and a focal distance to be offset in the vertical direction.
